(19) United States
(12) Patent Application Publication
(10) Pub. No.: US 2025/0146096 A1
(43) Pub. Date: May 8, 2025

(54) METHOD OF PRODUCING GRAIN-ORIENTED ELECTRICAL STEEL SHEET

(71) Applicant: JFE STEEL CORPORATION, Chiyoda-ku, Tokyo (JP)

(72) Inventors: Rieko IZUMI, Chiyoda-ku, Tokyo (JP); Toshito TAKAMIYA, Chiyoda-ku, Tokyo (JP); Akio FUJITA, Chiyoda-ku, Tokyo (JP); Toru NAKASHIMA, Chiyoda-ku, Tokyo (JP); Norihisa OKADA, Chiyoda-ku, Tokyo (JP)

(73) Assignee: JFE STEEL CORPORATION, Chiyoda-ku, Tokyo (JP)

(21) Appl. No.: 18/838,042

(22) PCT Filed: Mar. 2, 2023
(86) PCT No.: PCT/JP2023/007916

§ 371 Date: Aug. 13, 2024

(30) Foreign Application Priority Data
Mar. 2, 2022 (JP) 2022-032047

(51) Int. Cl. C21D 9/46; C21D 8/12

(52) U.S. Cl. CPC C21D 9/46; C21D 8/1222; C21D 8/1233; C21D 8/1238; C21D 8/1255; C21D 8/1261

(57) ABSTRACT

Provided is a way to inhibit propagation of edge cracks. A method of producing a grain-oriented electrical steel sheet including, before final annealing, local strain with an indentation amount from the steel sheet surface of 5 μm to 30 μm is applied to a linear region that, when coiled and the coil is charged into a final annealing furnace, is separated from the axial end of the coil that comes into contact with a coil receiving base of the final annealing furnace by 5 mm or more and 20 mm or less in the axial direction of the coil and that extends continuously or discontinuously in a direction on that intersects the axial direction, in order to produce crystal grains having a misorientation angle of 15° or more from Goss orientation grains along 50% or more of the total length of the linear region.

### TECHNICAL FIELD

The present disclosure relates to methods of producing grain-oriented electrical steel sheets, and in particular to a method of producing a grain-oriented electrical steel sheet able to prevent the propagation of a so-called edge crack occurring at the edge of the steel sheet during flattening annealing.

### BACKGROUND

As a soft magnetic material, grain-oriented electrical steel sheets are mainly used as iron core material for transformers, rotating equipment, and the like, and are required to have high magnetic flux density and low iron loss and magnetostriction. With the recent deterioration of the energy situation and the increase in capital investment due to aging power transmission facilities, there is a growing need to supply grain-oriented electrical steel sheets having excellent magnetic properties as economically as possible. To obtain a grain-oriented electrical steel sheet having excellent magnetic properties, it is necessary to obtain a secondary recrystallized microstructure in which crystal grains are highly concentrated in the Goss orientation, or {110}<001> orientation.

A grain-oriented silicon steel sheet is produced by hot rolling a steel slab adjusted to a defined chemical composition, performing hot-rolled sheet annealing as required, then cold rolling once or more than once with intermediate annealing, followed by decarburization annealing, applying and drying an annealing separator, coiling under a coiling tension, and then final annealing in a defined atmosphere.

In an annealing furnace where the final annealing is performed, the coil is placed with its coil axis perpendicular to a surface of a coil receiving base and exposed to high temperature for a long time. As a result, defects frequently occur at an end (hereinafter also referred to as an edge) of the coil on the side in contact with the coil receiving base. The most problematic defects that occur at the coil end are edge cracks caused by edge deformation. After the final annealing, flattening annealing is typically performed to flatten the coil and apply a coating. When an edge crack is present at this time, tension applied to the steel sheet during the flattening annealing increases the possibility of further propagation of the edge crack. An edge crack propagating to a large extent leads to fracture of the steel sheet, which is a major hindrance to productivity. Further, when an edge crack is present, the edge crack needs to be removed in a slitting process, which significantly decreases product throughput yield.

As methods to suppress edge deformation that causes edge cracking, there are known methods of applying striated strain to edges as described in Patent Literature (PTL) 1 and 2.

### CITATION LIST

### Patent Literature

PTL 1: JP H10-204542 A
PTL 2: JP 2001-323322 A

### SUMMARY

### Technical Problem

In recent years, the occurrence of edge cracks associated with coil end deformation has sometimes become noticeable, especially in thin grain-oriented silicon steel sheets such as those having a thickness of 0.20 mm or less. The techniques described in PTL 1 and 2 do not always suppress such edge cracks, and there is a need for improvement regarding propagation of edge cracks from the coil end.

It would be helpful to provide a way to inhibit propagation of edge cracks.

### Solution to Problem

The inventors studied edge crack propagation as described above and found that the propagation of edge cracks into a coil caused by deformation at the coil edge can be suppressed by controlling crystal grain orientation to a specific range in a linear strain region in the vicinity of the edge, thereby arriving at the present disclosure.

Primary features of the present disclosure are as follows.

1. A method of producing a grain-oriented electrical steel sheet, the method comprising:

hot rolling a silicon-containing steel slab; then cold rolling once or two or more times with intermediate annealing; then decarburization annealing; then applying an annealing separator; then winding into a coil; then final annealing; then flattening annealing, wherein
before the final annealing, local strain with an indentation amount from the steel sheet surface of 5 μm to 30 μm is applied to a linear region that, when coiled and the coil is charged into a final annealing furnace, is separated from the axial end of the coil that comes into contact with a coil receiving base of the final annealing furnace by 5 mm or more and 20 mm or less in the axial direction of the coil and that extends continuously or discontinuously in a direction that intersects the axial direction, in order to produce crystal grains having a misorientation angle of 15° or more from Goss orientation grains along 50% or more of the total length of the linear region.

2. The method of producing a grain-oriented electrical steel sheet according to 1, above, wherein a plurality of linear strain regions apply strain in the linear region.

3. The method of producing a grain-oriented electrical steel sheet according to 1 or 2, above, wherein an average heating rate in a range from 500° C. or more to 800° C. or less in the final annealing is 25° C./h or less.

### Advantageous Effect

According to the present disclosure, by introducing linear strain in the vicinity of the edge where edge cracks occur before secondary recrystallization, crystal grains different from Goss orientation grains can be generated in a strain-introduced portion in final annealing to inhibit edge cracks from propagating in the Goss orientation grains. Accordingly, edge trimming in a slitting process for silicon steel sheets that have gone through final processing can be reduced, thereby improving product yield rate.

### BRIEF DESCRIPTION OF THE DRAWINGS

In the accompanying drawings:

FIG. 1 is a diagram illustrating a state of coil placement in a final annealing furnace; and

FIG. 2 is a diagram illustrating inhibition of edge crack propagation in a strain-introduced portion.

### DETAILED DESCRIPTION

The method of production according to the present disclosure is described in detail below.

Typically, a grain-oriented silicon steel sheet is produced by hot rolling a steel slab adjusted to a defined chemical composition, performing hot-rolled sheet annealing as required, then cold rolling once or more than once with intermediate annealing, followed by decarburization annealing, applying and drying an annealing separator, coiling under a coiling tension, and then final annealing of the coil in a defined atmosphere.

According to the present disclosure, in the final annealing process described above, when the coil is charged into the finishing annealing furnace, local strain (with an indentation amount from the steel sheet surface of 5 μm to 30 μm) has been applied, before the final annealing, to a linear region that, when coiled, is separated from the axial end of the coil in contact with a coil receiving base of the final annealing furnace by 5 mm or more and 20 mm or less in the axial direction of the coil and that extends continuously or discontinuously in a direction that intersects the axial direction, to produce fine crystal grains other than Goss orientation grains in 50% or more of the total length of the linear region.

Each process is described in detail below.

### [Linear Region]

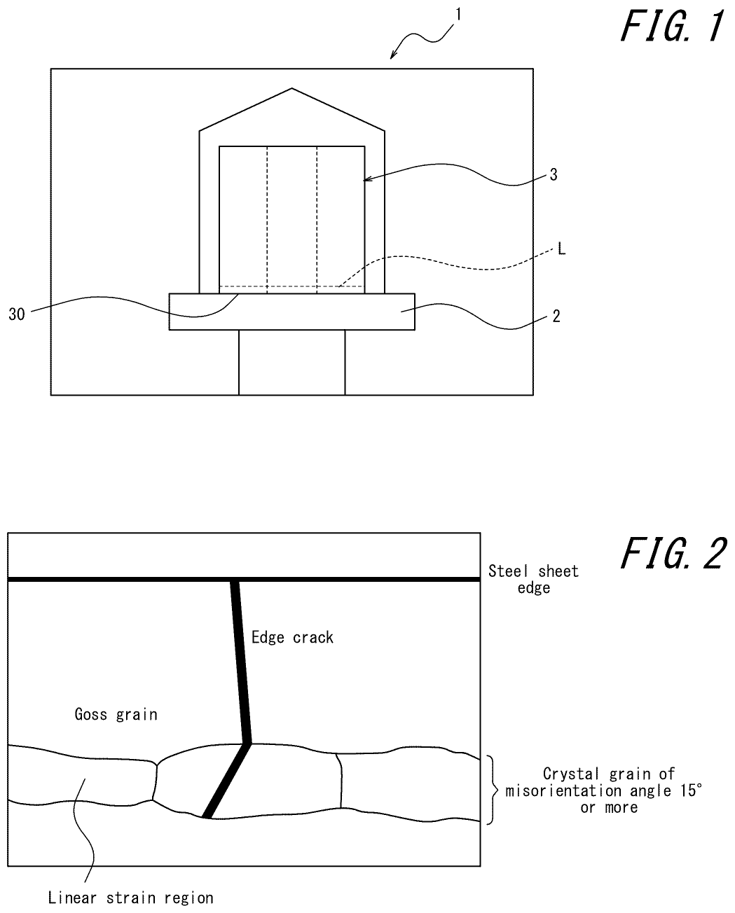

For example, as illustrated in FIG. 1, a coil receiving base 2 is provided in a final annealing furnace 1. After cold rolling, a steel strip is wound into a coil, and the coil 3 is placed on the coil receiving base 2 for final annealing. Local strain is applied to a linear region L that, when coiled, is separated from a coil end 30 on a side that is in contact with the coil receiving base 2 by 5 mm or more and 20 mm or less in the axial direction of the coil and that extends continuously or discontinuously in a direction that intersects the axial direction. Specifically, in the steel strip after cold rolling, the local strain described above is applied to one end perpendicular to the rolling direction, which is the coil end on the side that comes into contact with the coil receiving base 2.

Here, the reason why the linear region is defined as a region separated by 5 mm or more and 20 mm or less (hereinafter also referred to as separation length) in the coil axial direction from the coil end (the side that comes into contact with the receiving base) is described. A separation length of less than 5 mm is not sufficiently effective to inhibit propagation of edge cracks, while a separation length of more than 20 mm is not sufficient to improve industrial yield rate.

Further, the linear region is oriented to intersect the coil axis direction. The linear region is preferably orthogonal to the coil axis direction. Further, the linear region is preferably continuous, but may be discontinuous. In a discontinuous case, the total of a continuous portion is 80% or more of the total length of the coil orthogonal to the coil axial direction, which is desirable to obtain the effect of strain introduction described below.

### [Strain Introduction]

Next, the method of applying strain to the linear region described above need not be particularly limited as long as strain is introduced. A method of pressing a roller or needle having a sharp contact surface, in particular a carbide roller having an abacus bead shape, for example, is advantageously suited. At this time, partially pressing the steel sheet surface to a depth of 5 μm to 30 μm in the thickness direction from the steel sheet surface is important.

Here, the reason for setting the indentation amount to 5 μm to 30 μm is that, when the indentation amount is less than 5 μm, the effect of inhibiting propagation of edge cracks is small, while when the indentation amount exceeds 30 μm, deformation in the vicinity of the edge of the steel sheet is large, making winding the steel sheet difficult.

### [Linear Strain Region]

The steel strip processed as above is coiled, and the coil is placed on the coil receiving base in the annealing furnace so that the linear strain region is at the bottom end of the coil, and then the coil is subjected to final annealing. In this secondary recrystallization annealing of the final annealing, secondary recrystallized microstructure is formed with Goss orientation grains. At this time, in the linear strain region, recrystallization caused by the introduced strain precedes secondary recrystallization, and therefore fine recrystallized grains remain in the linear strain region even after secondary recrystallization occurs in the vicinity of the linear strain region.

In the linear strain region, it is essential that crystal grain having an orientation difference of 15° or more from the Goss orientation be generated in 50% or more of the total length of the linear region (the total length of the coil). Here, to generate crystal grains having an orientation difference of 15° or more from the Goss orientation in the linear strain region means to obtain recrystallized grains having an orientation difference of 15° or more from the Goss orientation that have grown by ½ or more in the thickness direction of the steel sheet, and that such crystal grains exist over 50% or more of the total length of the linear region (in the length direction of the coil). Further, in order to promote recrystallization having an orientation difference of 15° or more, the indentation amount in the linear region needs to be 5 μm or more and 30 μm or less. Further, the average heating rate in the range from 500° C. or more to 800° C. or less of the final annealing is preferably 25° C./h or less. A lower limit of the average heating rate in the temperature range is not particularly limited, and may be, for example, 3° C./h or more.

When fine crystal grains other than Goss grains, as described above, are present over 50% or more of the total length of the linear region, the propagation of edge cracks generated at edges to inside of the linear region can be effectively inhibited. As illustrated in FIG. 2, which schematically illustrates microstructure around the linear region from the edge of a steel sheet after secondary recrystallization annealing, an edge crack that propagates from the edge of the steel sheet into the steel sheet is blocked by the dispersion of the stress of edge crack propagation by fine crystal grains of orientation other than that of Goss grains generated at the strain-introduced portion. Crystal grains having a misorientation angle of 15° or more from that of Goss orientation grains are preferably present over 80% or more of the total length of the linear region and may be present over 100% of the total length. More preferably, crystal grains having a misorientation angle of 15° or more and 55° or less from that of Goss orientation grains are present over 80% or more of the total length of the linear region.

At least one linear strain region as described above is required, and two or more linear strain regions may be provided in the range from 5 mm to 20 mm from the coil end as described above. For example, from 1 to 30 linear strain regions may be provided. When a plurality of linear strain regions are provided, spacing between the linear strain regions is preferably 0.5 mm or more. For example, the spacing may be from 0.5 mm to 15 mm.

The present disclosure is applicable to any known grain-oriented electrical steel sheet because the introduction of strain to the linear region is able to reliably prevent propagation of edge cracks in grain-oriented electrical steel sheets. Accordingly, composition of the grain-oriented electrical steel sheet is not particularly limited, but the chemical composition indicated below may be adopted.
C: 0.01 mass % to 0.1 mass %,
Si: 2.0 mass % to 5.5 mass %, and
Mn: 0.02 mass % to 2.5 mass %,
   with the balance being iron and inevitable impurity. The reasons for limiting the content of each component are as follows.

### C: 0.01 Mass % to 0.1 Mass %

When C is less than 0.01%, there is a possibility that the effect of C on microstructure improvement is not sufficient. On the other hand, when C exceeds 0.1%, removal of C by decarburization annealing may become difficult.

### Si: 2.0 Mass % to 5.5 Mass %

Si is an element that increases specific resistance, which is a main function of electrical steel sheets. When Si is less than 2.0%, the increase in specific resistance may be insufficient, and when Si exceeds 5.5%, cold rolling manufacturability may degrade and production thereby becomes difficult.

### Mn: 0.02 Mass % to 2.5 Mass %

Mn has an effect of improving hot rolling manufacturability. When Mn is less than 0.02%, the improvement effect may be insufficient, and when Mn exceeds 2.5%, this may cause a decrease in saturation magnetic flux density of steel, which may be disadvantageous in practicality for transformer applications.

In addition to the above basic components, for the use of inhibitors, Al: 0.01 mass % to 0.04 mass % and N: 0.004 mass % to 0.01 mass % may be included, and as required, one or more of S or Se may be included in an amount from 0.005 mass % or more to 0.030 mass % or less.

On the other hand, in a case where no inhibitor is used, Al: 0.003 mass % to 0.01 mass % and N: 0.002 mass % to 0.006 mass %, may be included, and S and Se may each be included in an amount less than 0.005 mass %.

Further, in addition to the above basic components,
one or more elements may be included, selected from the group consisting of Ni: 0.01 mass % to 0.4 mass %, Cr: 0.01 mass % to 0.25 mass %, Cu: 0.01 mass % to 0.30 mass %, P: 0.005 mass % to 0.10 mass %, Sb: 0.005 mass % to 0.10 mass %, Sn: 0.005 mass % to 0.10 mass %, Bi: 0.005 mass % to 0.10 mass %, Mo 0.005 mass % to 0.10 mass %, B: 0.0002 mass % to 0.0025 mass %, Te: 0.0005 mass % to 0.01 mass %, Nb: 0.001 mass % to 0.01 mass %, V: 0.001 mass % to 0.01 mass %, and Ta: 0.001 mass % to 0.01 mass %.

### EXAMPLES

Steel slabs each containing C: 0.06 mass %, Si: 3.2 mass %, Mn: 0.05 mass %, Al: 0.005 mass %, and N: 0.004 mass % were heated to 1200° C., then hot rolled to 2.5 mm thickness, then subjected to hot-rolled sheet annealing at 1000° C. for 60 s, then finished to 0.19 mm thickness by one pass of cold rolling. The cold-rolled sheets were subjected to decarburization annealing in wet hydrogen at 820° C. for 120 s and wound into coils. Subsequently, linear strain was applied under various conditions as listed in Table 1 to a linear region that, when coiled, extends in a direction that intersects the coil axis direction, 8 mm in the coil axis direction from the edge of the decarburization annealing coil, to form a linear strain region. Next, final annealing was performed by changing the heating conditions in various ways. The final annealing was performed at a maximum temperature of 1180° C. for 5 h. After the final annealing, the product coil was subjected to flattening annealing at 800° C. for 60 s.

For the product coil thus obtained, the number of edge cracks per 100 m exceeding 8 mm in depth from the coil edge and the maximum depth of edge cracks that occurred were evaluated. Further, a length fraction of crystal grains having a misorientation angle of 15° or more from that of Goss orientation grains in the linear strain region was investigated. That is, the length fraction of crystal grains was determined by linear analysis of crystal orientation using an electron back-scattering pattern (EBSP) device at a central portion of the linear strain region toward the length direction of the coil.

These results are listed together in Table 1.

TABLE 1

| | | | | Length fraction | | | |
|---|---|---|---|---|---|---|---|
| | | | Final | of crystal grains | | | |
| | | | annealing | of orientation | | Edge | |
| | | | 500° C. to | difference 15° or | | crack | |
| | | Indentation | 800° C. | more from Goss | | maximum | |
| | Linear | amount | heating rate | orientation grains | Edge cracks | depth | |
| No. | strain | (μm) | (° C./h) | (%) | (per 100 m) | (mm) | Remarks |
| 1 | No | — | 20 | — | 8 | 20 | Comparative |
| | | | | | | | Example |
| 2 | Yes | 2.0 | 20 | 30 | 5 | 15 | Comparative |
| | | | | | | | Example |
| 3 | Yes | 5.0 | 20 | 50 | 1 | 10 | Example |
| 4 | Yes | 7.0 | 20 | 60 | 1 | 9 | Example |
| 5 | Yes | 10 | 20 | 75 | 0 | 8 | Example |
| 6 | Yes | 10 | 10 | 80 | 0 | 8 | Example |
| 7 | Yes | 30 | 20 | 85 | 0 | 8 | Example |

### INDUSTRIAL APPLICABILITY

According to the method of producing a grain-oriented electrical steel sheet of the present disclosure, by introducing linear strain in the vicinity of the edge where edge cracks occur before secondary recrystallization, crystal grains different from Goss orientation grains can be generated in a strain-introduced portion in final annealing to inhibit edge cracks from propagating in the Goss orientation grains. Accordingly, edge trimming in a slitting process for silicon steel sheets that have gone through final processing can be reduced, thereby improving product yield rate, which has high industrial utility.

### REFERENCE SIGNS LIST

1 final annealing furnace
2 coil receiving base
3 coil
30 coil end
L linear region

1. A method of producing a grain-oriented electrical steel sheet, the method comprising:
hot rolling a silicon-containing steel slab; then cold rolling once or two or more times with intermediate annealing; then decarburization annealing; then applying an annealing separator; then winding into a coil; then final annealing; then flattening annealing, wherein
before the final annealing, local strain with an indentation amount from the steel sheet surface of 5 μm to 30 μm is applied to a linear region that, when coiled and the coil is charged into a final annealing furnace, is separated from the axial end of the coil that comes into contact with a coil receiving base of the final annealing furnace by 5 mm or more and 20 mm or less in the axial direction of the coil and that extends continuously or discontinuously in a direction that intersects the axial direction, in order to produce crystal grains having a misorientation angle of 15° or more from Goss orientation grains along 50% or more of the total length of the linear region.

2. The method of producing a grain-oriented electrical steel sheet according to claim 1, wherein a plurality of linear strain regions apply strain in the linear region.

3. The method of producing a grain-oriented electrical steel sheet according to claim 1, wherein an average heating rate in a range from 500° C. or more to 800° C. or less in the final annealing is 25° C./h or less.

4. The method of producing a grain-oriented electrical steel sheet according to claim 2, wherein an average heating rate in a range from 500° C. or more to 800° C. or less in the final annealing is 25° C./h or less.
